(19) United States
(12) Patent Application Publication
(10) Pub. No.: US 2024/0134932 A1
(43) Pub. Date: Apr. 25, 2024

(54) DISTRIBUTED MATRIX COMPUTATION CONTROL METHOD AND APPARATUS SUPPORTING MATRIX FUSED OPERATION

(71) Applicant: Korea Advanced Institute of Science and Technology, Daejeon (KR)

(72) Inventors: Min-Soo KIM, Daejeon (KR); Donghyoung HAN, Daejeon (KR)

(21) Appl. No.: 18/479,290

(22) Filed: Oct. 2, 2023

(30) Foreign Application Priority Data
Oct. 13, 2022 (KR) 10-2022-0131741

(51) Int. Cl. G06F 17/16

(52) U.S. Cl. CPC G06F 17/16

(57) ABSTRACT

A distributed matrix computation control method to be performed by a distributed matrix computation control apparatus including a memory and a processor, the method comprises: generating a fusion plan configured to fuse matrix operators on the basis of matrix multiplication based on a query plan, meta information of input matrices, and system resource information; representing the fusion plan as a three-dimensional model space; and assigning the input matrices to cores or nodes respectively corresponding to cuboids through cuboid-based fusion space partitioning to execute a fused operation according to the fusion plan.

### CROSS-REFERENCE TO RELATED APPLICATION

This application claims priority to Korean Patent Application No. 10-2022-0131741, filed on Oct. 13, 2022. The entire contents of the application on which the priority is based are incorporated herein by reference.

### TECHNICAL FIELD

The present disclosure relates to a distributed matrix computation control method supporting a matrix fused operation and a distributed matrix computation control apparatus performing the method.

This work was supported by Institute of Information & communications Technology Planning & Evaluation (IITP) grant funded by the Korea government(MSIT) (Project unique No.: 1711152412; Project No.: 2019-O-01267-004; R&D project: SW Computing Industry Source Technology Development Project; Research Project Title: (SW Star Lab) Development of High-speed Multi-type Graph Database Engine SW based on GPU; and Project period: 2022.01.01.˜2022.12.31.), and National Research Foundation of Korea(NRF) grant funded by the Korean Government (MSIT) (Project unique No.: 1711163646; Project No.: 2017R1E1A1A01077630; R&D project: Personal Basic Research(MSIT); Research Project Title: Convergence Technology Research to Bridge the Gap between Machine Learning and Deep Learning Systems and Database Systems; and Project period: 2022.03.01.˜2022.10.31.), and Institute of Information & communications Technology Planning & Evaluation (IITP) grant funded by the Korean Government (MSIT) (Project unique No.: 1711160301; Project No.: 2020-O-01795-003; R&D project: Nurturing ICT and Broadcasting Innovation Talents; Research Project Title: Development of High-Reliability and High-Usability Big Data Platform and Analysis Prediction Service Technology in the Edge Cloud; and Project period: 2022.01.01.˜2022.12.31.), and National Research Foundation of Korea(NRF) grant funded by the Korean Government (MSIT) (Project unique No.: 1711157269; Project No.: 2018R1A5A1060031; R&D project: Group Research Support; Research Project Title: Dark Data Extreme Utilization Research Center; and Project period: 2022.03.01.˜2023.02.28.).

### BACKGROUND

Matrix operation has been widely used in modern society as a basic operation that is the basis of most algorithms in the field of computer science, such as traditional linear systems such as recommendation systems, machine learning, and graphic rendering.

Due to a recent increase in the size of matrix data used in recommender systems and machine learning, it has become difficult to perform matrix algorithms or queries in one node, and thus distributed matrix computation system capable of processing matrix operations by distributing matrix data to computation nodes by utilizing parallel and distributed matrix systems in which computation nodes are connected by a network has become more important.

In particular, complex queries such as machine learning contain more than dozens of matrix operators. Intermediate result matrices between operators are materialized according to a data structure in a use of a matrix computation system. Hundreds of materialization processes are required to be performed by more than hundreds of operators, and a large number of materialization processes adversely affect the overall query processing performance. Matrix computation systems use operator fusion to perform multiple matrix basic operators as a single fused operator in order to reduce query processing time.

Computation systems that compute representative matrices, such as Apache's SystemDS and Google's TensorFlow, generally do not incorporate large-scale matrix multiplication. This operation is one of the operators with the highest communication cost and memory consumption within fusion plans. This omission is due to the consideration of the potential for query execution failure. This is because distributed fusion operator methods used in the systems for executing the fusion plans may fail query execution when involving large matrix multiplications.

Existing matrix computation systems represent a query plan as a directed acyclic graph (DAG) and find sub-DAG partial fusion plans on the directed acyclic graph. A query plan that includes one or more of these partial fusion plans is called a fusion plan. The fusion plan including fusion operators that match a partial fusion plan is created and the fusion plan is executed in a distributed fashion. A distributed fusion operator is composed of three stages: matrix integration stage, local operation stage, and matrix aggregation stage.

In the matrix integration stage, input matrices required by each task (or node on a cluster) are integrated. In the local operation stage, a fused operation is performed by using blocks assigned to each task and intermediate blocks are generated. In the matrix aggregation stage, an aggregation operation is performed by redistributing the intermediate blocks on the cluster to produce final results. The matrix aggregation stage is optionally performed depending on the presence of the last aggregation operator in the partial fusion plan.

Existing distributed matrix computation systems typically use two distributed fusion operators: a broadcast-based distributed fusion operator and a replication-based distributed fusion operator. Differences between the two methods occur depending on how input matrices are partitioned in the matrix integration stage.

The broadcast-based distributed fusion operator is a method of partitioning a main matrix having the largest number of elements among input matrices into tasks on a cluster and broadcasting the remaining auxiliary matrices to all tasks. In this method, as the size of the auxiliary matrices decreases, query processing performance is improved due to lower communication cost, but the memory usage rate is high since all the auxiliary matrices need to be loaded task memory and execution fails if the size of the auxiliary matrices becomes larger than the task memory.

The replication-based distributed fusion operator is a method of partitioning a main matrix into tasks, and copying and allocating blocks of all auxiliary matrices required to generate a result block of a fused operation based on the block of the main matrix allocated to the tasks. Since this method uses only necessary blocks for generating a result block, it has the advantage of less memory usage rate than the broadcast method but has the disadvantage of high communication cost due to redundant replicated blocks of auxiliary matrices as the size of the main matric increases.

As described above, considering an importance of the distributed matrix fusion operator, research on an efficient distributed matrix fusion operator method that satisfies both the matrix size and network cost aspects, research on a method of generating a fusion plan including large-scale matrix multiplication, and a distributed matrix computation system using the same are required.

### SUMMARY

According to an embodiment, a distributed matrix computation control method and apparatus for generating a fusion plan that fuses matrix operators on the basis of matrix multiplication, representing the fusion plan as a 3D model space, and then executing a fused operation according to the fusion plan through cuboid-based fusion space partitioning are provided.

In accordance with a first aspect, there is provided a distributed matrix computation control method to be performed by a distributed matrix computation control apparatus including a memory and a processor, the method comprises: generating a fusion plan configured to fuse matrix operators on the basis of matrix multiplication based on a query plan, meta information of input matrices, and system resource information; representing the fusion plan as a three-dimensional model space; and assigning the input matrices to cores or nodes respectively corresponding to cuboids through cuboid-based fusion space partitioning to execute a fused operation according to the fusion plan.

In accordance with a second aspect, there is provided a distributed matrix computation control apparatus, the apparatus comprises: a memory; and a processor, wherein the processor is configured to generate a fusion plan configured to confuse matrix operators on the basis of matrix multiplication based on a query plan, meta information of input matrices, and system resource information, to represent the fusion plan as a three-dimensional model space, to assign the input matrices to cores or respectively corresponding to cuboids through cuboid-based fusion space partitioning, and to execute a fused operation according to the fusion plan.

In accordance with a third aspect, there is provided a non-transitory computer-readable storage medium storing computer executable instructions, wherein the instructions, when executed by the processor, cause the processor to perform a distributed matrix computation control method, the method comprising: generating a fusion plan configured to fuse matrix operators on the basis of matrix multiplication based on a query plan, meta information of input matrices, and system resource information; representing the fusion plan as a three-dimensional model space; and assigning the input matrices to cores or nodes respectively corresponding to cuboids through cuboid-based fusion space partitioning to execute a fused operation according to the fusion plan.

According to an embodiment, a method of finding a fusion plan based on large-scale matrix multiplication and a fused operation for matrices larger than the size of storage devices available in a parallel processing machine can be performed. In a parallel processing machine, as many operators as possible are fused on the basis of matrix multiplication based on a query plan, meta information of input matrices, and information on system resources, and the fused operation is represented in a 3D model space to find an optimal space partitioning method, and thus a fusion plan based on large-scale matrix multiplication can be created and a fused operation can be performed on large-scale matrices based on the fusion plan.

In addition, unlike existing methods that avoid including large-scale matrix multiplication in a partial fusion plan at the time of generating a fusion plan from a query plan, as many operators as possible are fused based on matrix multiplication and rule-based and cost-based models using information on input matrices and available hardware resource information are used, and thus it is possible to create an optimal fusion plan in terms of communication cost and memory usage.

In addition, unlike existing methods that use fixed partitioning methods for input matrices having various sizes, distributed fused operations can be performed as an optimal partitioning method in terms of communication cost because a cost-based model is used using information on input matrices.

Furthermore, since the size of the cuboid of a fused space is determined based on available resources such as a main memory of the system, the largest fused operation that can be processed in the current system situation can be performed.

The problem to be solved by the present disclosure is not limited to those described above, and another problem to be solved that is not described may be clearly understood by those skilled in the art to which the present disclosure belongs from the following description.

### BRIEF DESCRIPTION OF THE DRAWINGS

FIG. 1 is a block diagram showing a distributed matrix computation control apparatus according to an embodiment of the present disclosure.

FIG. 2 is a diagram showing a structure of a matrix computation system including the distributed matrix computation control apparatus according to an embodiment of the present disclosure.

FIG. 3 is a table listing symbols used in the figures of the present disclosure and the meanings thereof.

FIG. 4 is a flowchart illustrating generation of a fusion plan and execution of a fused operation according to a distributed matrix computation control method according to an embodiment of the present disclosure.

FIG. 5 is a flowchart showing a matrix multiplication-based fusion plan generation step according to the distributed matrix computation control method according to an embodiment of the present disclosure.

FIG. 6 is a flowchart showing a method of determining matrix multiplication-based fusion plan candidate groups according to the distributed matrix computation control method according to an embodiment of the present disclosure.

FIGS. 7A and 7B are a flowchart showing a method of determining a final fusion plan among candidate groups according to the distributed matrix computation control method according to an embodiment of the present disclosure.

FIG. 8 is a flowchart showing a step of computing optimal parameters and costs in a given partial fusion plan according to the distributed matrix computation control method according to an embodiment of the present disclosure.

FIGS. 9A and 9B are a flowchart showing a method of computing communication cost, memory usage, and computational cost using a given partial fusion plan and parameters according to the distributed matrix computation control method according to an embodiment of the present disclosure.

FIG. 10 is a flowchart showing a method of executing a fused operation according to the distributed matrix computation control method according to an embodiment of the present disclosure.

FIG. 11 is a flowchart showing a method of executing a cuboid-based fusion operator according to the distributed matrix computation control method according to an embodiment of the present disclosure.

FIG. 12 is a flowchart showing a cuboid-based fusion space partitioning method according to the distributed matrix computation control method according to an embodiment of the present disclosure.

FIG. 13 is a flowchart showing a fused operation method according to the distributed matrix computation control method according to an embodiment of the present disclosure.

FIGS. 14A-14B are diagrams showing examples of a cuboid-based partitioning method according to the distributed matrix computation control method according to an embodiment of the present disclosure.

FIG. 15A is a diagram showing examples of a cuboid-based partitioning method according to the distributed matrix computation control method according to an embodiment of the present disclosure.

FIG. 15B is a diagram showing examples of a cuboid-based partitioning method according to the distributed matrix computation control method according to an embodiment of the present disclosure.

FIG. 15C is a diagram showing examples of a cuboid-based partitioning method according to the distributed matrix computation control method according to an embodiment of the present disclosure.

FIG. 15D is a diagram showing examples of a cuboid-based partitioning method according to the distributed matrix computation control method according to an embodiment of the present disclosure.

### DETAILED DESCRIPTION

The above and other objectives, features, and advantages of the present disclosure will be easily understood from the following preferred embodiments in conjunction with the accompanying drawings. However, the present disclosure may be embodied in different forms without being limited to the embodiments set forth herein. Rather, the embodiments disclosed herein are provided to make the disclosure thorough and complete and to sufficiently convey the spirit of the present disclosure to those skilled in the art. The scope of the present disclosure is merely defined by the claims.

In the following description of the present disclosure, detailed descriptions of known functions and configurations which are deemed to make the gist of the present disclosure obscure will be omitted. Since the terms can be differently defined according to the intention of a user or an operator or customs, these terms should be interpreted as having a meaning that is consistent with the technical spirit of the present disclosure.

The functional blocks shown in the drawings and described below are only possible implementations. Other functional blocks may be used in other implementations without departing from the spirit and scope of the detailed description. In addition, while one or more functional blocks of the present disclosure are represented as individual blocks, one or more of the functional blocks of the present disclosure may be a combination of various hardware and software configurations that perform the same function.

Further, the expression “certain components are included” simply indicates that corresponding components are present, as an open expression, and should not be understood as excluding additional components.

Furthermore, it should be understood that when an element is referred to as being “coupled” or “connected” to another element, it can be directly coupled or connected to the other element or intervening elements may be present therebetween.

Further, it will be understood that the terms “first”, “second”, etc. are used herein to distinguish one element from another element, these terms do not limit the order or other features between the elements.

Hereinafter, the embodiments of the present disclosure will be described with reference to the accompanying drawings.

According to an embodiment of the present disclosure, even if given hardware resources such as the number of cores of a main processing unit and the size of a main storage device are different from characteristics such as size, sparsity, dimension, and the like of matrices based on a matrix multiplication operation, a distributed matrix computation system that supports optimal fusion plan generation and a distributed fusion operator in terms of processing performance and communication cost efficiency can be provided.

According to an embodiment, a fusion plan composed of partial fusion plans obtained by fusing as many operators as possible depending on a given hardware environment based on a matrix multiplication operation on a directed acyclic graph of a query plan can be generated.

According to an embodiment, in order to execute an arbitrary partial fusion plan, optimal distributed fusion operators in terms of processing time, communication cost, and memory usage can be provided through cost-based analysis using cuboid-based partitioning for a 3-dimensional model space of matrix fused operation.

According to an embodiment, all matrix operators can be represented as a 3D model space depending on the dimensions of an input matrix and a result matrix, and a fusion operator can be represented by connecting matrix operators included in a partial fusion plan and input and result matrices in a 3D model space.

According to an embodiment, for a fused operation including matrix multiplication, matrix multiplication of a matrix A of I×K and a matrix B of K×J may be represented as a 3-dimensional model of I×K×J, and the matrices A and B may be results of the fused operation connected to matrix multiplication. In addition, the result of matrix multiplication may be an input to a fused operator after the matrix multiplication.

According to an embodiment, a fused operation including matrix multiplication may be represented by four left fusion, right fusion, output fusion, and matrix multiplication spaces. The matrix multiplication space is a 3D model space of matrix multiplication included in the fused operation, the left and right fusion spaces are fusion spaces that have an input matrix of matrix multiplication as a result matrix, and the output fusion space may be a fusion space having the result matrix of matrix multiplication as an input.

According to an embodiment, searching for all partitioning methods that may occur in a distributed fused operation is provided through a cuboid partitioning method for four fusion spaces using three parameters of P, Q, and R in a 3D model of a fused operation including matrix multiplication, and thus an optimal partitioning method can be provided according to a cost-based model.

According to an embodiment, since a partition including partitioned cuboids in each space partitioned through the cuboid portioning method is partitioned to fit a memory size available in nodes and at the same time to minimize communication cost, the performance of distributed fusion operators can be guaranteed hundreds of times and tens of times higher than existing method in terms of execution time and communication cost.

According to an embodiment of the present disclosure, generation and execution of a fusion plan may include a step of searching for matrix operators that can be fused in a query plan in the form of a given directed acyclic graph and generating a matrix multiplication-based fusion plan for a given query plan based on generating a fusion plan including one or more partial fusion plans by including the operators in a partial fusion plan in the form of a sub-DAG, and a fused operation execution step of executing a matrix operator or a fusion operator matching each vertex in the fusion plan in order to execute the fusion plan based on the fusion plan.

A matrix computation system to which a fusion plan generation and execution method is applied is driven in a parallel processing machine and may include a plurality of central processing units that control respective steps, a main storage device that temporarily stores some blocks of input matrices, and an auxiliary storage device that stores all input matrices and result matrices.

The matrix computation system may be managed through a distributed matrix computation control apparatus. More specifically, the distributed matrix computation control apparatus is one thread of a central processing unit in the case of a parallel processing machine, and serves as a coordinator node, one of nodes in the case of a small cluster composed of multiple machines, and the other nodes may be worker nodes managed by the coordinator node.

The distributed matrix computation control apparatus may include a matrix multiplication-based fusion plan generator that performs a matrix multiplication-based fusion plan generation step and a cuboid-based fused operation executor that performs a fused operation execution step.

The matrix multiplication-based fusion plan generator may include a matrix multiplication-based partial fusion plan candidate group determination module based on a query plan in the form of a directed acyclic graph given by a user or a system, meta information of input matrices to be used for the query plan, such as a dimension size, sparsity, and size, and system information such as the number of total cores, the number of nodes, and the size of a main storage device available for cores, and a fusion plan determination module that determines optimal partial fusion plans according to system resources given in the candidate group.

The matrix multiplication-based partial fusion plan candidate group determination module may search for a matrix multiplication operator in the given query plan and determine partial fusion plan candidate groups by fusing neighboring operators based on the operator through a rule-based method.

In a case in which the fusion plan determination module receives partial fusion plan candidate groups from the matrix multiplication-based partial fusion plan candidate group determination module, the fusion plan determination module may repeat a process of dividing a candidate group into two fusion plan candidate groups through a cost-based method or determining the candidate group as a final partial fusion plan if the candidate group includes two or more matrix multiplication operators while searching the candidate groups until all the partial fusion plan candidate groups are determined as final partial fusion plans, thereby determine a final fusion plan.

The cuboid-based fused operation executor may include a fusion plan search module for searching for a fusion plan based on a fusion plan received from the matrix multiplication-based fusion plan generator, a basic operator execution module for executing an operator matching a vertex in the fusion plan searched by the fusion plan search module, a cuboid-based fusion space partitioning module for executing a partial fusion plan searched by the fusion plan search module, and a fused operation execution module for executing a fused operation for a partition created by the fusion space partitioning module.

The fusion plan search module may determine a vertex or a partial fusion plan to be executed next by searching the directed acyclic graph of the fusion plan in order to compute the result of the given fusion plan.

The basic operator execution module may receive the vertex to be executed next from the fusion plan search module and execute a distributed matrix operator matching the vertex.

The cuboid-based fusion space partitioning module may partition three-dimensional model spaces of partial fusion plans into partitions having an optimal size on the basis of the partial fusion plan to be executed next from the fusion plan search module, meta information of input matrices necessary for execution of a fusion plan, and available hardware resources of a cluster, and assign blocks of the input matrices included in the partitions to respective tasks.

The fused operation execution module may receive a partition composed of blocks of input matrices from the cuboid-based fusion space partitioning module and perform a fused operation matching a partial fusion plan. If necessary, a final result block may be created by aggregating intermediate result blocks through communication between tasks to create a final result block.

A matrix computation system may include a plurality of central processing units, a main storage device, and a plurality of auxiliary storage devices connected through PCI_E and SATA interfaces. The main storage device can be used to the maximum by using cores which are computational resources of the central processing unit of the matrix computation system. The main storage device can load partitions composed of multiple blocks.

The main storage device and a core which are computational resources can receive partitions and perform fused operations that match the corresponding partitions. If necessary, after performing cumulative aggregation computation by shuffling intermediate result blocks, result matrix blocks may be stored in the auxiliary storage devices.

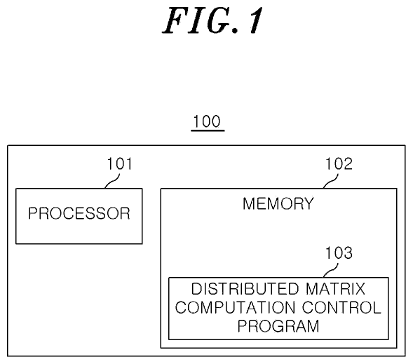

FIG. 1 is a block diagram showing a distributed matrix computation control apparatus according to an embodiment of the present disclosure.

Referring to FIG. 1, the distributed matrix computation control apparatus 100 may include a processor 101, a memory 102, and a distributed matrix computation control program 103.

The processor 101 may control the overall operation of the distributed matrix computation control apparatus 100.

The memory 102 may store the distributed matrix computation control program 103 and information necessary to execute the distributed matrix computation control program 103.

The distributed matrix computation control program 103 may refer to software including instructions programmed to perform distributed matrix computation control.

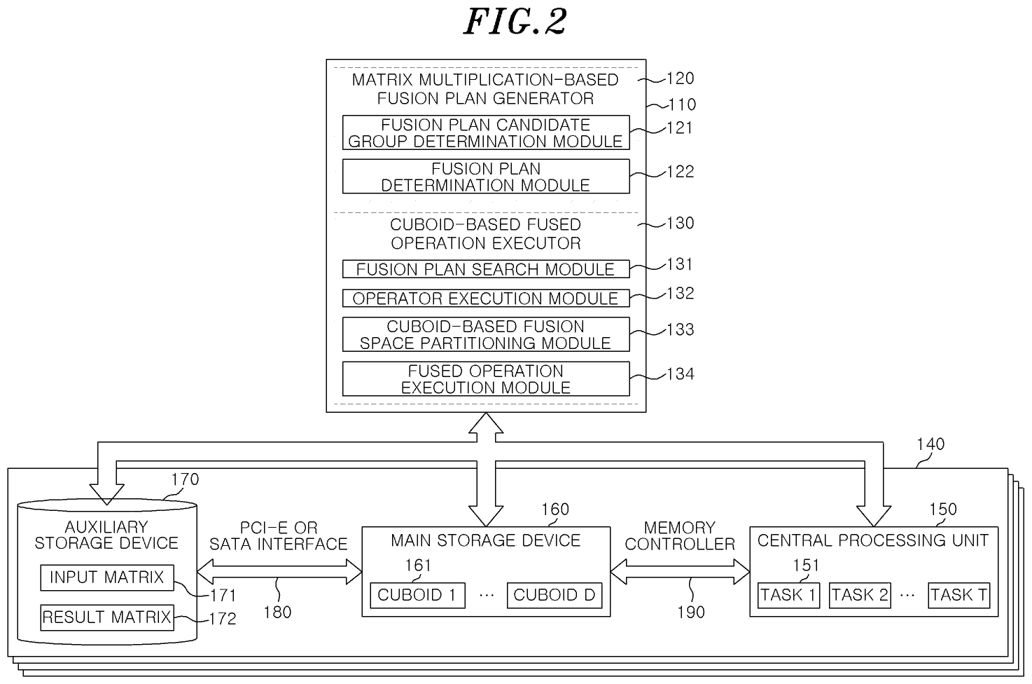

To execute the distributed matrix computation control program 103, the processor 101 may load the distributed matrix computation control program 103 and the information necessary to execute the distributed matrix computation control program 103 from the memory 102. FIG. 2 is a diagram showing a structure of a matrix computation system including the distributed matrix computation control apparatus according to an embodiment of the present disclosure.

Referring to FIG. 2, the matrix computation system according to an embodiment includes a distributed matrix computation control apparatus 110 and cores or nodes 140. Here, the cores or nodes 140 may be nodes of a general computer or server cluster.

The distributed matrix computation control apparatus 110 includes a matrix multiplication-based fusion plan generator 120 that generates a matrix multiplication-based fusion plan and a cuboid-based fused operation executor 130 that performs a cuboid-based fused operation.

The matrix multiplication-based fusion plan generator 120 may generate a fusion plan that fuses matrix operators based on matrix multiplication on the basis of a query plan, meta information of input matrices, and system resource information.

The matrix multiplication-based fusion plan generator 120 may include a fusion plan candidate group determination module 121 and a fusion plan determination module 122.

The fusion plan candidate group determination module 121 may determine a partial fusion plan candidate group by fusing neighboring operators through a rule-based method for all matrix multiplication operators in a query plan. The matrix multiplication-based fusion plan generator 120 may generate a matrix multiplication-based fusion plan candidate group based on a query plan in the form of a directed acyclic graph given by a user or a system, meta information of input matrices to be used for the query plan, such as a dimension size, sparsity, and size, and system information such as the total number of cores, the number of nodes, and the size of a main storage device available for a core. A query plan is given as an input factor to the fusion plan candidate group determination module 121, and the fusion plan candidate group determination module 121 may search for the query plan in the form of an acyclic graph and determine matrix multiplication-based partial fusion plan candidate groups through a rule-based method.

The fusion plan determination module 122 may determine a fusion plan from a partial fusion plan candidate group through a cost-based method based on meta information of input matrices and system resource information. The fusion plan determination module 122 may determine optimal partial fusion plans depending on given system resources from the candidate group. The fusion plan determination module 122 may receive fusion plan candidate groups from the fusion plan candidate group determination module 121 and determine a final fusion plan through a cost-based method depending on an available main storage device size for each core and communication and computational costs while searching the candidate groups.

The cuboid-based fused operation executor 130 may include a fusion plan search module 131 that searches for a fusion plan in order to execute the fusion plan, an operator execution module 132 that executes a searched operator, a cuboid-based fusion space partitioning module 133 and a fused operation execution module 134 that execute a searched partial fusion plan with a fusion operator. Here, the fusion plan search module 131 may search for operators that are not executed in the fusion plan, receive the fusion plan in the form of a directed acyclic graph, visit vertices corresponding to operators in the fusion plan, and select the operators to execute the operators. In a case in which a searched operator is a basic matrix operator, the operator execution module 132 may execute the operator without representing it in a 3D model space. The cuboid-based fusion space partitioning module 133 may perform cuboid-based fusion space partitioning when the searched operator is determined as a fusion operator. The fused operation execution module 134 may execute a fused operation in which cuboid-based fusion space partitioning is performed, generate a plurality of cuboids using a input matrcies based on parameters determined by using meta information of the input matrices and system resource information, and then allocate each cuboid among the plurality of cuboids to the cores or nodes.

The matrix multiplication-based fusion plan generator 120, the fusion plan candidate group determination module 121, the fusion plan determination module 122, the cuboid-based fused operation executor 130, the fusion plan search module 131, the operator execution module 132, the cuboid-based fusion space partitioning module 133, and the fused operation execution module 134 are conceptual divisions of the functions of the distributed matrix computation control apparatus 110, and the present disclosure is not limited thereto.

According to an embodiment, the functions of the matrix multiplication-based fusion plan generator 120, the fusion plan candidate group determination module 121, the fusion plan determination module 122, the cuboid-based fused operation executor 130, the fusion plan search module 131, the operator execution module 132, the cuboid-based fusion space partitioning module 133, and the fused operation execution module 134 may be merged/separated and implemented as a series of instructions included in one program.

The matrix multiplication-based fusion plan generator 120, the fusion plan candidate group determination module 121, the fusion plan determination module 122, the cuboid-based fused operation executor 130, the fusion plan search module 131, the operator execution module 132, the cuboid-based fusion space partitioning module 133, and the fused operation execution module 134 may be implemented by the processor 101 and may refer to a data processing device embedded in hardware having a physically structured circuit to execute functions represented as code or instructions included in the distributed matrix computation control program 103 stored in the memory 102.

The cores or nodes 140 are hardware constituting a computer and may include a plurality of central processing units 150, a main storage device 160, and at least one auxiliary storage device 170. The central processing unit 150 may allocate tasks 151 required in a distributed matrix computation step from the distributed matrix computation control apparatus 110 to each core. The number of tasks 151 may be determined depending on a parallelism level and the number of cores of the central processing unit 150. The main storage device 160 can load cuboids 161 configured by the cuboid-based fused operation executor 130. The central processing unit 150 and the main storage device 160 may be connected through a memory controller 190. The main storage device 160 and the auxiliary storage device 170 may be connected through a PCI-E or SATA interface 180 or through various other interfaces. The entire auxiliary storage device 170 connected to at least all computation nodes may be large sufficiently to contain an input matrix 171 and a result matrix 172.

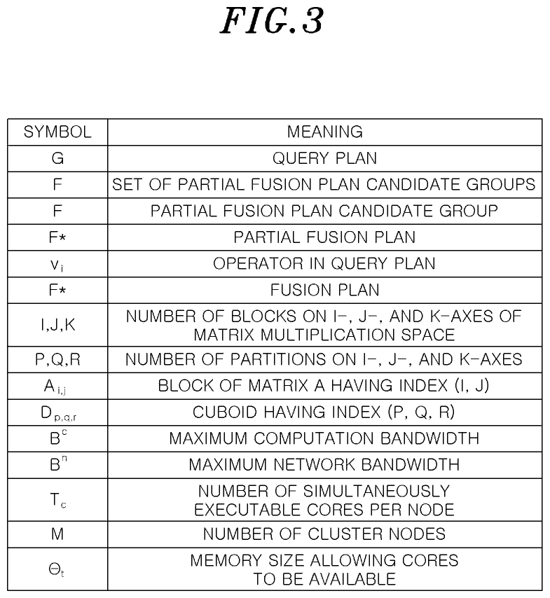

Refer to the table shown in FIG. 3 for symbols used in the following embodiments and the meanings thereof.

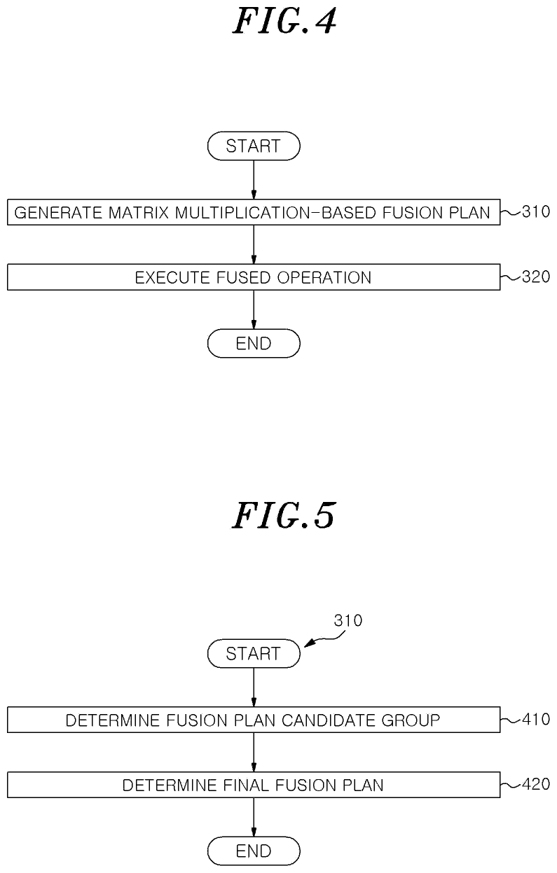

FIG. 4 is a flowchart illustrating generation of a fusion plan and execution of a fused operation according to a distributed matrix computation control method according to an embodiment of the present disclosure. Referring to FIG. 4, a fusion plan based on matrix multiplication may be generated from a query plan (310), and computation for obtaining a query result may be executed while searching for the determined fusion plan (320).

A method of generating a fusion plan from a query plan input from a user or system using the matrix multiplication-based fusion plan generator 120 in step 310 will be described with reference to FIG. 5.

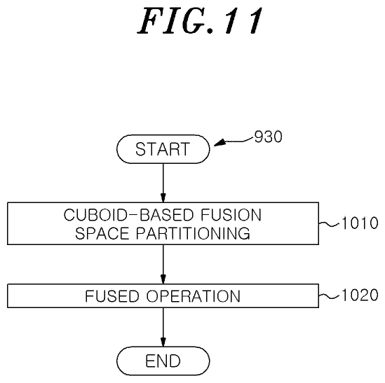

In step 320, to obtain a query result by searching for a fusion plan determined by the matrix multiplication-based fusion plan generator 120 in the cuboid-based fused operation executor 130 using the fusion plan search module 131, operators are executed using the operator execution module 132, the cuboid-based fusion space partitioning module 133, and the fused operation execution module 134, and the operators may load the input matrix 171 stored in the auxiliary storage device 170 to the main storage device 160 and perform operations. A method of executing a fusion plan using the cuboid-based fused operation executor 130 will be described with reference to FIG. 11.

FIG. 5 is a flowchart showing a matrix multiplication-based fusion plan generation step according to the distributed matrix computation control method according to an embodiment of the present disclosure. After fusion plan candidate groups are determined through a rule-based method in order to generate a fusion plan from a given query plan (410), a final fusion plan may be determined from the given candidate groups through a cost-based method (420).

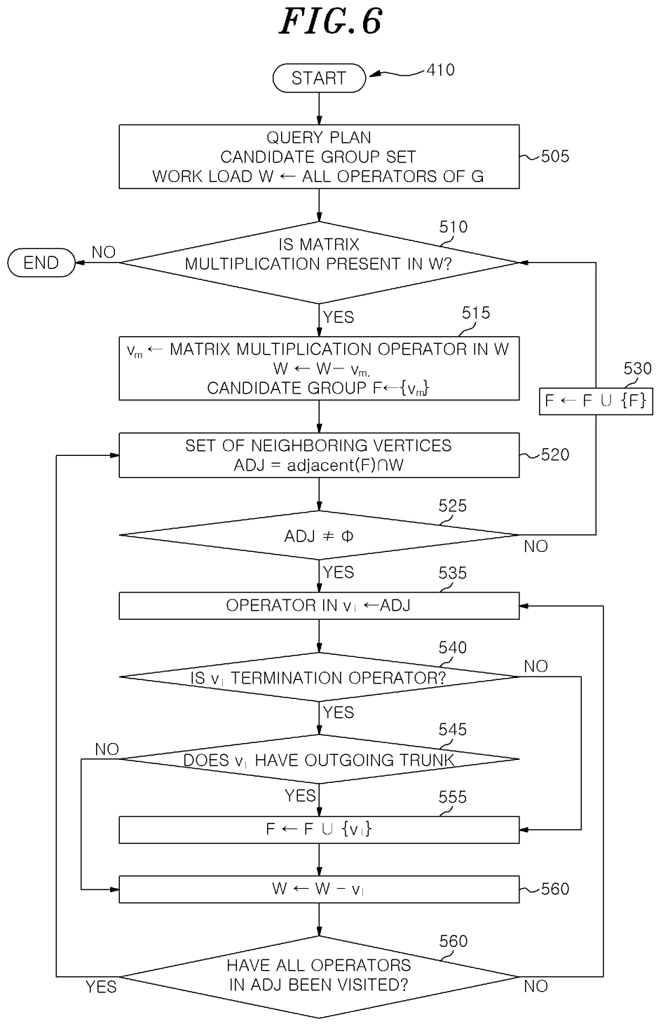

In step 410, a query plan in the form of a directed acyclic graph is received, and partial fusion plan candidate groups may be determined using the fusion plan candidate group determination module 121. A method of determining a partial fusion plan candidate group will be described with reference to FIG. 6.

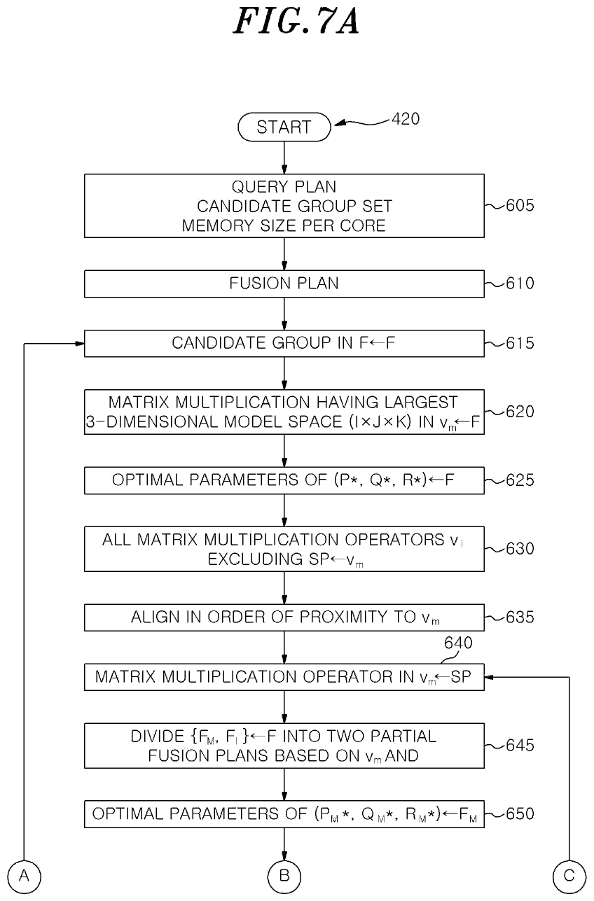

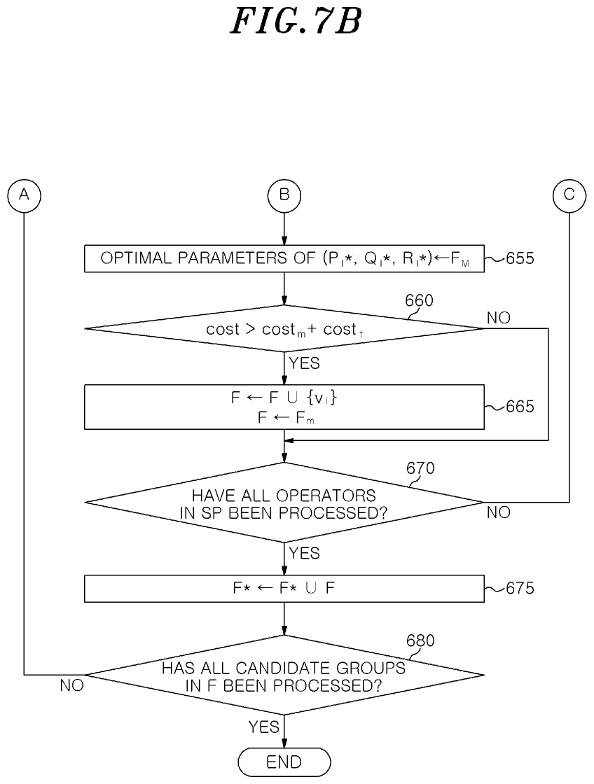

In step 420, in order to determine partial fusion plan candidate groups generated after step 410 as a final fusion plan, the fusion plan determination module 122 may determine the final fusion plan through a cost-based method using memory usage, communication cost, computational cost, and the like. A method of determining the final fusion plan will be described with reference to FIGS. 7A and 7B.

FIG. 6 is a flowchart showing a method of determining a matrix multiplication-based fusion plan candidate group according to the distributed matrix computation control method according to an embodiment of the present disclosure. A partial fusion plan candidate group may be determined by fusing as many neighboring operators 520 as possible based on a matrix multiplication operator 510 in the query plan through rule-based methods 540 and 545.

In step 505, a candidate group set [symbol] is initialized, and all operators in the query plan can be assigned to a set W.

In step 510, the operators in W can be searched to find the matrix multiplication operator. In step 515, a new partial fusion plan candidate group F can be initialized together with the matrix multiplication operator vₘ.

In step 520, adjacent vertices present around the candidate group F can be found. That is, adjacent vertices connected to vertices present in the candidate group F can be found, and if the adjacent vertices already belong to other candidate groups or have been processed, they can be excluded.

If there is no adjacent vertex in step 525, the candidate group F can be determined as a partial fusion plan candidate group through step 530.

In step 535, one operator vᵢ is selected from among the adjacent vertices and it is determined whether to include the operator vᵢ in the candidate group F through a rule-based method.

In step 540, it is checked whether vᵢ is an operator that needs to terminate fused operation. An operator that needs to terminate fused operation may mean an aggregation operator in which a result matrix of the operator must be materialized, or an operator that requires shuffling through a network in a distributed environment. If vᵢ is not a termination operator, it can be included in the candidate group F through step 550.

In step 545, it is checked whether vᵢ is a termination operator and is executed at the end of the current partial fusion plan candidate group. If vᵢ is an operator executed last, it is included in the candidate group in step 550, but if not, it may not be included.

In step 555, vᵢ can be removed from the set W such that it is not redundantly included in the candidate group.

In step 560, it is checked whether all of the adjacent vertices of the candidate group F have been processed, and step 520 to step 560 are repeated until there are no more adjacent vertices of the candidate group F to determine the candidate group F. If there is no matrix multiplication operator in W or all of matrix multiplication operators have been processed, candidate groups determined so far can be passed to the next step, a final fusion plan determination step.

FIGS. 7A and 7B are a flowchart showing a method of determining a final fusion plan among candidate groups according to the distributed matrix computation control method according to an embodiment of the present disclosure. Memory usage, communication, and computational costs when each candidate group is executed are predicted (625), costs are compared with candidate groups (645) that can be derived from the corresponding candidate group (660), and a candidate group having the lowest cost can be determined as a final partial fusion plan.

In step 605, a query plan, a set of candidate groups determined by the fusion plan candidate group determination module 121, and a memory size available per core can be received as input factors.

In step 610, a final fusion plan [symbol] * can be initialized.

In step 615, a candidate group F can be selected from a candidate group set [symbol] .

In step 620, an operator vₘ with the largest dimension I×J×K of an input matrix can be found among matrix multiplication operators belonging to the candidate group F.

In step 625, when the candidate group F is executed using a cuboid-based fusion operator, optimal parameters and costs can be computed. A method for computing optimal parameters and costs will be described with reference to FIG. 8.

In steps 630 and 635, matrix multiplication operators vᵢ excluding vₘ can be found in the candidate group F and aligned in order of proximity to vₘ on the DAG.

In step 640, vᵢ can be selected in order of proximity.

In step 645, the candidate group F can be divided into two candidate groups {Fₘ, Fᵢ} based on vₘ and vᵢ.

Costs for the two candidate groups divided in steps 650 and 655 can be computed.

In step 660, costs of the candidate group F and the two divided candidate groups {Fₘ, Fᵢ} can be compared.

In step 665, if the cost is low when the candidate group is divided into two candidate groups, Fₘ which has only one matrix multiplication operator in the candidate group is determined as a final partial fusion plan, and candidate group Fᵢ can be included in the candidate group set [symbol] F in order to check whether it can be further derived.

In step 670, it can be checked whether cost comparison has been performed for all matrix multiplication operators in the candidate group F.

In step 675, since cost comparison has been performed for all matrix multiplication operators and execution of fused operation in the current state is optimal for the candidate group F, the candidate group F can be included in the final fusion plan.

In step 680, it can be checked whether all candidate groups in the candidate group set have been processed.

FIG. 8 is a flowchart showing a step of computing optimal parameters and costs in a given partial fusion plan according to the distributed matrix computation control method according to an embodiment of the present disclosure.

In step 710, the current cost can be initialized to the largest value that can be expressed as an integer.

In a case in which a partial fusion plan is executed with a cuboid-based fusion operator in step 720, candidate groups of possible parameters can be determined.

In step 730, one of the parameter candidate groups can be selected.

In step 740, it can be checked whether the number of tasks that can be executed with the current parameter is greater than the number of currently available cores. If the number of tasks is less than the number of cores, the current parameter can be skipped and the next parameter can be selected again.

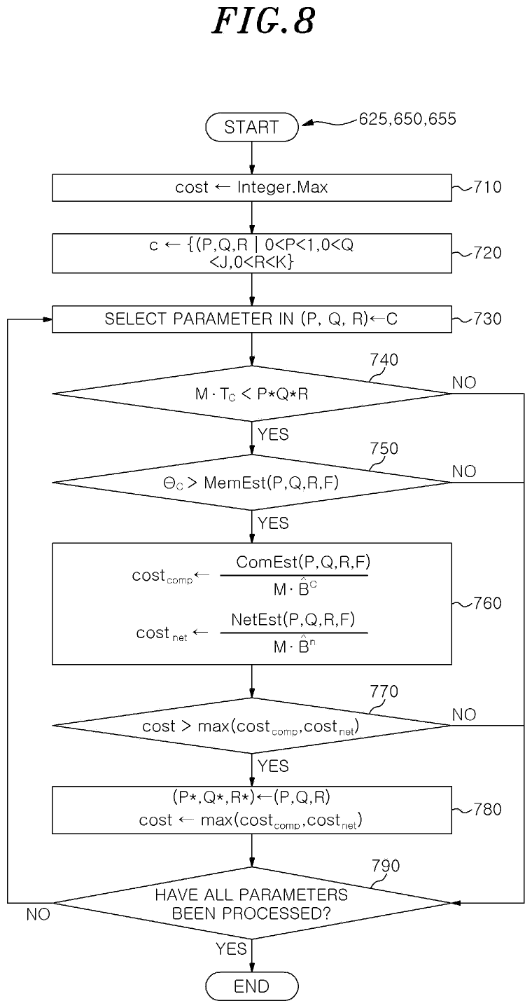

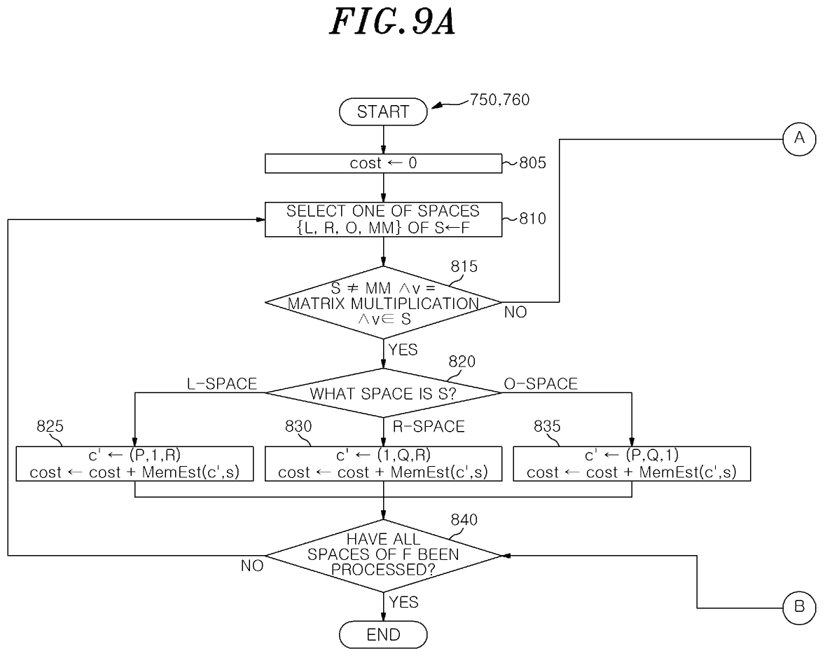

If the current parameter is used, it can be checked whether one cuboid can be loaded into the available memory per core in step 750. A method of computing memory usage will be described with reference to FIGS. 9A and 9B.

When the current parameter is used, communication cost and computational cost can be normalized and obtained using the highest network and computation bandwidth for comparison in step 760. A method of computing communication and computational costs will be described with reference to FIGS. 9A and 9B.

In step 770, the larger cost of the communication cost and the computational cost can be compared with the current cost.

In step 780, if the cost is lower when the current parameter is used, the corresponding parameter can be determined as an optimal parameter at the present time.

In step 790, it can be checked whether all parameter candidate groups have been processed.

FIGS. 9A and 9B are a diagram illustrating a process of computing memory, communication, and computational costs when a partial fusion plan F and parameters P, Q, and R are provided according to the distributed matrix computation control method according to an embodiment of the present disclosure. The same process can be used to compute the three costs. In step 805, the initial cost can be initialized to zero.

In step 810, the partial fusion plan F can be divided into four fusion spaces {L, R, O, MM} based on the matrix multiplication operator, and one can be selected therefrom.

In step 815, it can be checked whether a selected space s is not the MM-space and includes the matrix multiplication operator. If the selected space does not include the matrix multiplication operator or is the MM-space, the process can proceed to step 845.

If the selected space s is the L-space, the process corresponding to FIGS. 9A and 9B can be re-executed as a recursive function by setting parameters P, 1, and R and the space s as input factors in step 825.

If the selected space s is the R-space, the process corresponding to FIGS. 9A and 9B can be re-executed as a recursive function by setting parameters 1, Q, and R and the space s as input factors in step 830.

If the selected space s is the O-space, the process corresponding to FIGS. 9A and 9B can be re-executed as a recursive function by setting parameters P, Q, and 1 and the space s as input factors in step 835.

In step 840, it can be checked whether all fusion spaces of given F have been processed.

In step 845, one of input matrices included in the selected space s can be selected. At the time of computing the computational cost, one of the operators included in the selected space s can be selected.

In step 850, it can be checked whether the selected input matrix is materialized. If the selected input matrix is materialized, it is actually used for memory and communication and thus costs can be computed. If the selected input matrix is not materialized, another matrix can be selected without computing costs for the selected matrix.

If the selected space s is the L-space, memory, communication, and computational costs incurred due to the currently selected matrix or operator can be computed in step 860. Here, if the current process is used to compute the cost for memory usage, the cost for memory usage can be computed using cost←cost+size (v)·1/p·R.

In steps 865, 870, and 875, similarly to step 860, memory, communication, and computational costs can be computed for cases in which the selected space s is the R-, O-, and MM-spaces.

In step 880, it can be checked whether all operators or matrices belonging to the space s have been processed.

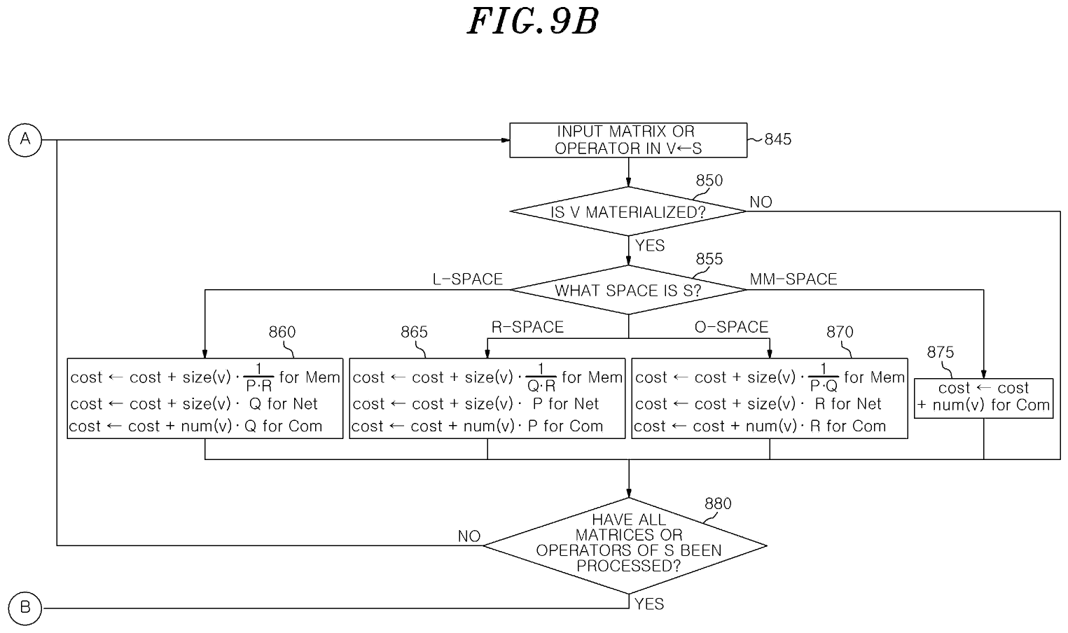

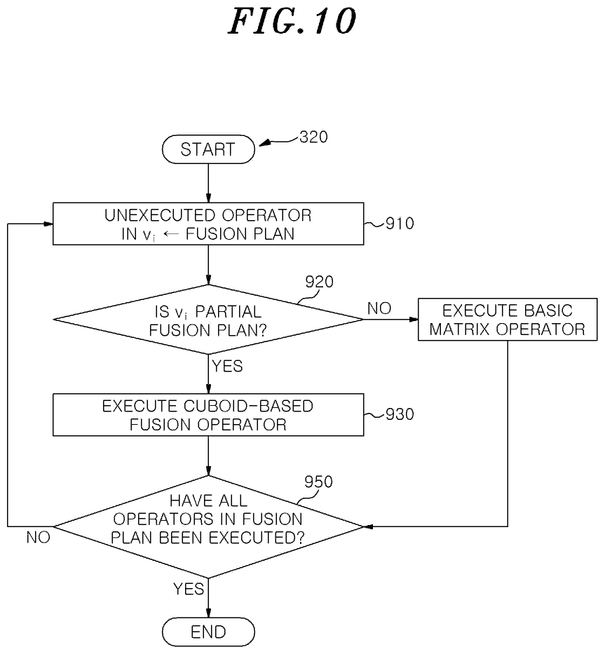

FIG. 10 is a flowchart showing a method of executing a fused operation according to the distributed matrix computation control method according to an embodiment of the present disclosure. The cuboid-based fused operation executor 130 may receive a fusion plan generated by the matrix multiplication-based fusion plan generator 120, search for the fusion plan using the fusion plan search module 131, execute visited operators using the operator execution module 132 if the visited operators are basic matric operators, and execute a cuboid-based fused operation method using the cuboid-based fusion space portioning module 133 and the fused operation execution module 134 if the visited operators are fusion operators.

In step 910, an operator that is not executed in the fusion plan can be visited and selected using the fusion plan search module 131 for the given fusion plan.

In step 920, it can be checked whether the selected operator is a partial fusion plan.

In step 930, the selected operator can be executed using a cuboid-based fusion operator if the selected operator is a partial fusion plan. The step of executing the cuboid-based fusion operator will be described with reference to FIG. 11.

If the selected operator is a basic matrix operator, the selected operator can be executed using the operator execution module 132 in step 940.

In step 950, it can be checked whether all operators in the fusion plan have been executed.

FIG. 11 is a flowchart showing a method of executing a cuboid-based fusion operator according to the distributed matrix computation control method according to an embodiment of the present disclosure.

In step 1010, input matrices of a partial fusion plan can be allocated to cores using the cuboid-based fusion space partitioning method. The partitioning method will be described with reference to FIG. 12.

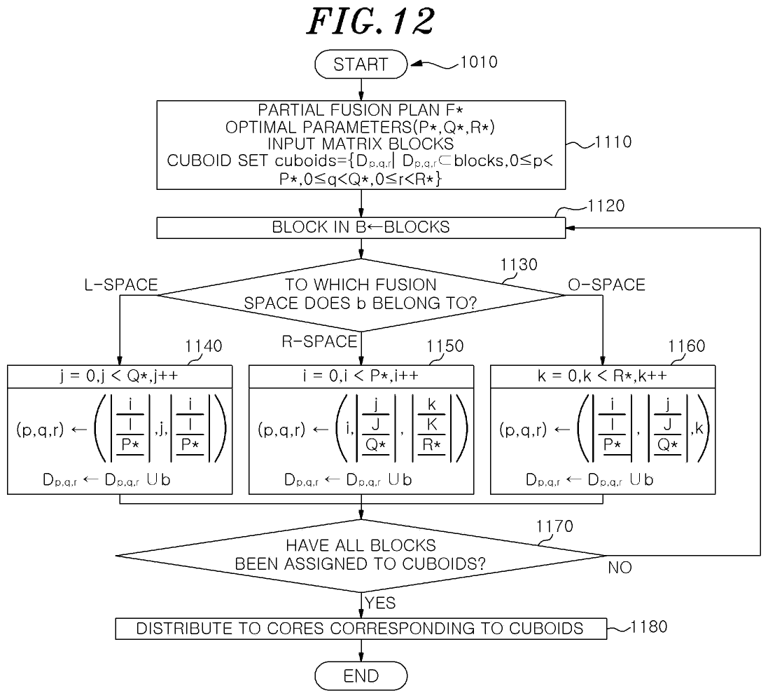

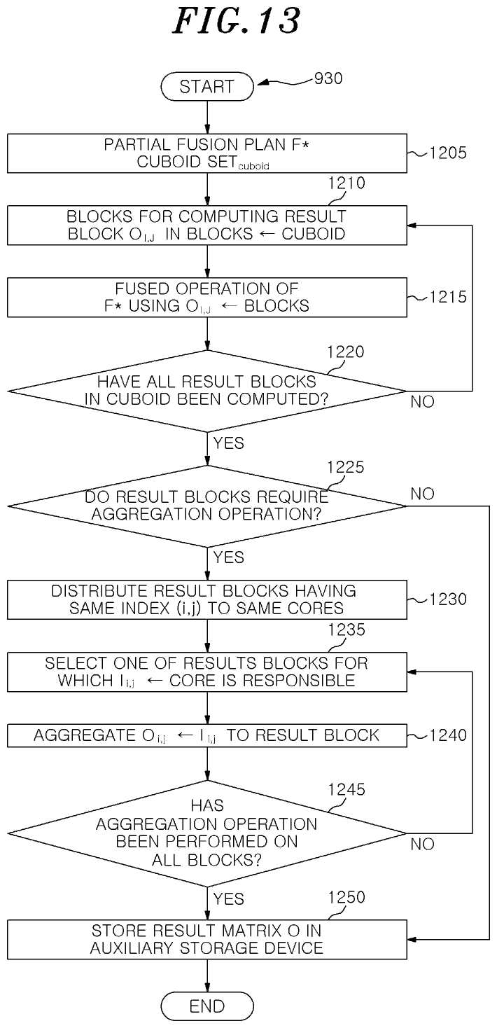

In step 1020, each core can perform a fused operation of the partial fusion plan using a cuboid including blocks of allocated input matrices. Execution of the fused operation will be described with reference to FIG. 13.

FIG. 12 is a flowchart showing a cuboid-based fusion space partitioning method according to the distributed matrix computation control method according to an embodiment of the present disclosure and illustrates a method of allocating input matrices to cores using the cuboid-based space partitioning method using optimal parameters determined according to a given partial fusion plan and available hardware resource conditions.

In step 1110, a partial fusion plan, optimal parameters, and input matrix blocks can received as input factors, and cuboids can be initialized based on the optimal parameters.

In step 1120, b which is one of the input matrix blocks can be selected.

In step 1130, the fusion space to which b belongs can be checked.

If b belongs to an L-space in step 1140, indices of Q* cuboids can be computed and assigned to the cuboids in step 1160. If b belongs to an R-space, indices of R* cuboids can be computed and assigned to the cuboids. If b belongs to an O-space, indices of R* cuboids can be computed and assigned to the cuboids.

In step 1170, it can be checked whether all blocks have been assigned to the cuboids.

In step 1180, the cuboids can be distributed to cores or nodes respectively corresponding to the cuboids.

FIG. 13 is a diagram illustrating a partial fusion plan fused operation method using blocks in a cuboid performed by a core or node that has received the cuboid according to an embodiment.

In step 1205, a partial fusion plan and a cuboid can be received as inputs.

In step 1210 to 1220, blocks necessary to compute a result block O_{i,j} in a result matrix of a fused operation are selected from the cuboid (1210), the fused operation is performed using the selected blocks to compute the result block O_{i,j} (1215), and it can be checked whether all result blocks that can be computed using the cuboid have been computed (1220).

In steps 1225 to 1250, it can be determined whether an aggregation operation is necessary together with result blocks of cuboids allocated to other cores or nodes in the partial fusion plan (1225), result blocks having the same index can be distributed to the same cores or nodes if the aggregation operation is necessary (1230), the necessary aggregation operation can be performed using the result blocks having the same index (1235, 1240, and 1245), and a final result matrix can be stored in an auxiliary storage device (1250).

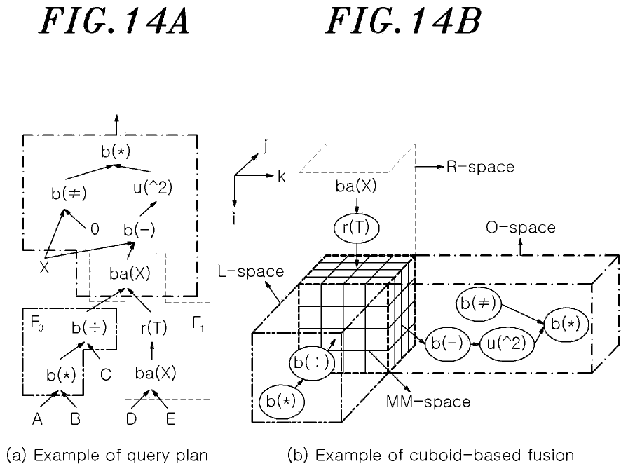

FIG. 14 is a diagram illustrating an example of a method of representing a 3D model space for an arbitrary query plan. In a case in which a partial fusion plan is generated for an arbitrary query plan of (a), it can be represented as a 3D model space as in (b). In (a), leaf nodes A, B, C, D, E, and X serve as input matrices, and upper nodes can represent operators. Here, ba(×) means matrix multiplication. If the partial fusion plan of (a) is represented as a 3-dimensional model space, a matrix multiplication operator commonly included in F₁ and F₂ in (a) may be represented as a 3-dimensional MM-space composed of i, j, and k axes in (b). F₀ which has the left input matrix of the MM-space is represented as an L-space of (b), and F₁ and F₂ may be represented as an R-space and an O-space, respectively.

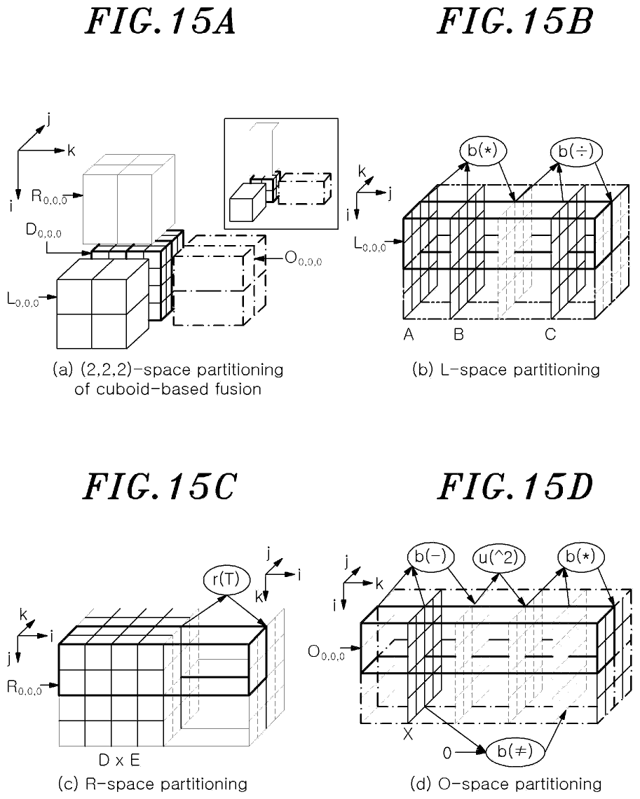

FIG. 15 is a diagram illustrating an example of a cuboid-based space partitioning method for a 3D model space for a partial fusion plan. (a) shows an example of partitioning the 3D model space which is the example of FIG. 14(a) using parameters (P=2, Q=2, and R=2). The MM-space is partitioned into P*Q*R=8 cuboids using a (P, Q, R) cuboid partitioning method, and the cuboid having the origin index can be D_{0,0,0}. L-, R-, and O-spaces may be partitioned through a cuboid partitioning method using (P=2, 1, R=2), (1, Q=2, R=2), and (P=2, Q=2, 1), respectively. (b), (c), and (d) show the L-, R-, and O-spaces partitioned by each partitioning method in detail. Blocks represented by dotted lines may mean that they have not been materialized. In (b), input matrices A, B, and C are arranged in a row, and blocks having the same index are assigned to the same cuboids. Here, the output matrix may not be materialized because it is input to matrix multiplication of the MM-space. In (c), since input matrices D and E are multiplied by matrix multiplication, they are represented in the form of voxels, and the result matrix of the multiplication becomes an input to the MM-space as in (b) and thus it may not be materialized. Even in (d), all intermediate matrices may not be materialized and the final output matrix may be materialized.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A distributed matrix computation control method to be performed by a distributed matrix computation control apparatus including a memory and a processor, comprising:
generating a fusion plan configured to fuse matrix operators on the basis of matrix multiplication based on a query plan, meta information of input matrices, and system resource information;
representing the fusion plan as a three-dimensional model space; and
assigning the input matrices to cores or nodes respectively corresponding to cuboids through cuboid-based fusion space partitioning to execute a fused operation according to the fusion plan.

2. The distributed matrix computation control method of claim 1, wherein the generating the fusion plan comprises:
determining a partial fusion plan candidate group by fusing neighboring operators through a rule-based method for all matrix multiplication operators in the query plan; and
determining the fusion plan from the partial fusion plan candidate group through a cost-based method based on the meta information of the input matrices and the system resource information.

3. The distributed matrix computation control method of claim 1, wherein the assigning the input matrices to cores or nodes comprises:
searching for an unexecuted operator in the fusion plan;
determining whether the searched unexecuted operator is a basic matrix operator or a fusion operator; and
executing the fused operation without representing the fusion plan as the three-dimensional model space if the searched unexecuted operator is determined as the basic matrix operator and executing the fused operation through the cuboid-based fusion space partitioning if the searched unexecuted operator is determined as the fusion operator.

4. The distributed matrix computation control method of claim 3, wherein the searching for the unexecuted operator comprises:
receiving the fusion plan in the form of a directed acyclic graph (DAG);
visiting a vertex corresponding to a operator in the fusion plan; and
selecting the operator corresponding to the vertex to execute the operator.

5. The distributed matrix computation control method of claim 3, wherein the executing the fused operation through the cuboid-based fusion space partitioning comprises:
generating a plurality of cuboids using the input matrices based on a parameter determined by using the meta information of the input matrices and the system resource information and assigning each cuboid among the plurality of cuboids to the cores or the nodes.

6. A distributed matrix computation control apparatus comprising:
a memory; and
a processor,
wherein the processor is configured to generate a fusion plan configured to confuse matrix operators on the basis of matrix multiplication based on a query plan, meta information of input matrices, and system resource information, to represent the fusion plan as a three-dimensional model space, to assign the input matrices to cores or respectively corresponding to cuboids through cuboid-based fusion space partitioning, and to execute a fused operation according to the fusion plan.

7. The distributed matrix computation control apparatus of claim 6, wherein the processor is configured to determine a partial fusion plan candidate group by fusing neighboring operators through a rule-based method for all matrix multiplication operators in the query plan and to determine the fusion plan from the partial fusion plan candidate group through a cost-based method based on the meta information of the input matrices and the system resource information.

8. The distributed matrix computation control apparatus of claim 6, wherein the processor is configured to search for an unexecuted operator in the fusion plan, to determine whether the searched unexecuted operator is a basic matrix operator or a fusion operator, to execute the fused operation without representing the fusion plan as the three-dimensional model space if the searched unexpected operator is determined as the basic matrix operator, and to execute the fused operation through the cuboid-based fusion space partitioning if the searched unexecuted operator is determined as the fusion operator.

9. The distributed matrix computation control apparatus of claim 8, wherein the processor is configured to receive the fusion plan in the form of a directed acyclic graph (DAG), to visit a vertex corresponding to a operator in the fusion plan, and to select the operator corresponding to the verteex to execute the operator.

10. The distributed matrix computation control apparatus of claim 8, wherein the processor is configured to generate a plurality of cuboids using the input matrices based on a parameter determined by using the meta information of the input matrices and the system resource information and to assign each cuboid among the plurality of cuboids to the cores or the nodes.

11. A non-transitory computer-readable storage medium storing computer executable instructions, wherein the instructions, when executed by the processor, cause the processor to perform a distributed matrix computation control method, the method comprising:
generating a fusion plan configured to fuse matrix operators on the basis of matrix multiplication based on a query plan, meta information of input matrices, and system resource information;
representing the fusion plan as a three-dimensional model space; and
assigning the input matrices to cores or nodes respectively corresponding to cuboids through cuboid-based fusion space partitioning to execute a fused operation according to the fusion plan.

12. The non-transitory computer-readable storage medium of claim 11, wherein the generating the fusion plan comprises:
determining a partial fusion plan candidate group by fusing neighboring operators through a rule-based method for all matrix multiplication operators in the query plan; and
determining the fusion plan from the partial fusion plan candidate group through a cost-based method based on the meta information of the input matrices and the system resource information.

13. The non-transitory computer-readable storage medium of claim 11, wherein the assigning the input matrices to cores or nodes comprises:
searching for an unexecuted operator in the fusion plan;
determining whether the searched unexecuted operator is a basic matrix operator or a fusion operator; and
executing the fused operation without representing the fusion plan as the three-dimensional model space if the searched unexecuted operator is determined as the basic matrix operator and executing the fused operation through the cuboid-based fusion space partitioning if the searched unexecuted operator is determined as the fusion operator.

14. The non-transitory computer-readable storage medium of claim 13, wherein the searching for the unexecuted operator comprises receiving the fusion plan in the form of a directed acyclic graph (DAG), visiting a vertex corresponding to a operator in the fusion plan, and selecting the operator corresponding to the vertex to execute the operator.

15. The non-transitory computer-readable storage medium of claim 13, wherein the executing the fused operation through the cuboid-based fusion space partitioning comprises:
generating a plurality of cuboids using the input matrices based on a parameter determined by using the meta information of the input matrices and the system resource information and assigning each cuboid among the plurality of cuboids to the cores or the nodes.
